(19) United States
(12) Patent Application Publication
(10) Pub. No.: US 2014/0211630 A1
(43) Pub. Date: Jul. 31, 2014

(54) MANAGING PACKET FLOW IN A SWITCH FARIC

(71) Applicants: Vincent E. Cavanna, Loomis, CA (US); Michael G. Frey, Granite Bay, CA (US)

(72) Inventors: Vincent E. Cavanna, Loomis, CA (US); Michael G. Frey, Granite Bay, CA (US)

(21) Appl. No.: 14/238,519

(22) PCT Filed: Sep. 28, 2011
(86) PCT No.: PCT/US2011/053697

§ 371 Date: Feb. 12, 2014

(51) Int. Cl. H04L 12/801; H04L 12/823; H04L 12/26

(52) U.S. Cl. CPC H04L 47/12; H04L 43/0888; H04L 47/32
USPC 370/235

(57) ABSTRACT

In a method for managing packet flow in a switch fabric comprising a plurality of fabric chips, wherein a packet comprises a counter, a determination as to whether the packet has been detoured around an unavailable fabric link and a determination as to whether the packet is making forward progress are made. In addition, a value of the counter in the packet is modified in response to a determination that the packet has been detoured around an unavailable fabric link and a determination that forward progress is not being made.

### BACKGROUND

Computer performance has increased and continues to increase at a very fast rate. Along with the increased computer performance, the bandwidth capabilities of the networks that connect the computers together have and continue to also increase significantly. Ethernet-based technology is an example of a type of network that has been modified and improved to provide sufficient bandwidth to the networked computers. Ethernet-based technologies typically employ network switches, which are hardware-based devices that control the flow of packets based upon destination address information contained in the packets. In a switched fabric, network switches connect with each other through a fabric, which allows for the building of network switches with scalable port densities. The fabric typically receives data from the network switches and forwards the data to other connected network switches.

### BRIEF DESCRIPTION OF THE DRAWINGS

Features of the present disclosure are illustrated by way of example and not limited in the following figure(s), in which like numerals indicate like elements, in which:

FIG. 1 illustrates a simplified schematic diagram of a network apparatus, according to an example of the present disclosure;

FIG. 2 shows a simplified block diagram of the fabric chip depicted in FIG. 1, according to an example of the present disclosure;

FIGS. 3, 4A, and 4B, respectively, show simplified block diagrams of switch fabrics, according to examples of the present disclosure; and

FIG. 5 shows a flow diagram of a method for managing packet flow in a switch fabric comprising the fabric chips of FIGS. 1-4B, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “n” and “m” following a reference numeral is intended to denote an integer value that is greater than 1. In addition, ellipses (“. . . ”) in the figures are intended to denote that additional elements may be included between the elements surrounding the ellipses. Moreover, the terms “a” and “an” are intended to denote at least one of a particular element. As used herein, the term “includes” means includes but not limited to, the term “including” means including but not limited to. The term “based on” means based at least in part on.

In various instances, packets may accumulate in a switch fabric, for instance, when the topology of the switch fabric changes and the packets are unable to reach their intended destination fabric down-links. When this occurs, packets accumulate inside the switch fabric, which may cause the resources inside the switching fabric to be heavily used, thereby causing dead-lock. This may also lead to the packet being communicated in an infinite loop inside the switch fabric. Previous attempts at preventing dead-lock included the use of a hop counter, which keeps track of the number of fabric chips in the switch fabric the packet has traversed. In this “hop counter” technique, once the hop counter reaches a specified limit, the packet is terminated. The “hop counter” technique, however, must grow in size as the number of fabric chips inside the switch fabric grows, and thus, often requires a relatively large packet overhead to accommodate the increasing size of the hop counter. In addition, the “hop counter” technique is often relatively restrictive because it increments with each hop, even if the packet is progressing towards its intended destination.

Disclosed herein are a fabric chip, a switch fabric comprising the fabric chip, and a method for managing packet flow in the switch fabric. The fabric chip, switch fabric, and method disclosed herein are implemented to prevent fabric dead-lock due to the accumulation of packets that fail to exit the switch fabric. As discussed in greater detail herein below, the fabric chip, switch fabric, and method disclosed herein terminate a packet from the switch fabric when a counter that tracks both when the packet is determined to have been detoured around an unavailable fabric link and when forward progress by the packet has not been made has rolled-over. That is, for instance, the packet is terminated from the switch fabric when the counter has reached a predetermined value (or zero) and has been reset to zero “0” (or to the predetermined value). In addition, a fabric chip may determine that a packet is making forward progress in the switch fabric when the packet is sent to or from one of the down-link port interfaces from the fabric chip or when the packet is sent to one of the preferred up-link port interfaces of the fabric chip. In the latter case, the sending of the packet to one of the preferred up-link fabric ports is an indication that the packet has not been detoured due to an unavailable fabric link.

Through implementation of the fabric chip, switch fabric, and method disclosed herein, switch fabric dead-lock may substantially be avoided while requiring minimal packet overhead and eliminating the maximum fabric hop count for the packet's “time-to-live”. In one regard, the fabric chip, switch fabric, and method disclosed herein avoids switch fabric dead-lock through a relatively more lenient process than the “hop counter” technique.

As recited herein, trunked links between network switches or fabric chips in a switch fabric may be defined as two or more fabric links that join the same pair of network switches or fabric chips in the switch fabric. In other words, trunked links comprise parallel links. In addition, a trunk may be defined as the collection of trunked links between the same pair of network switches or fabric chips. Thus, for instance, a first trunk of trunked links may be provided between a first network switch and a second network switch, and a second trunk of trunked links may be provided between the first network switch and a third network switch. Packets may be communicated between the network switches over any of the trunked links joining the network switches.

As used herein, packets may comprise data packets and/or control packets. According to an example, packets comprise data and control mini-packets (MPackets), in which control mpackets are Requests or Replies and data mpackets are Unicast and/or Multicast.

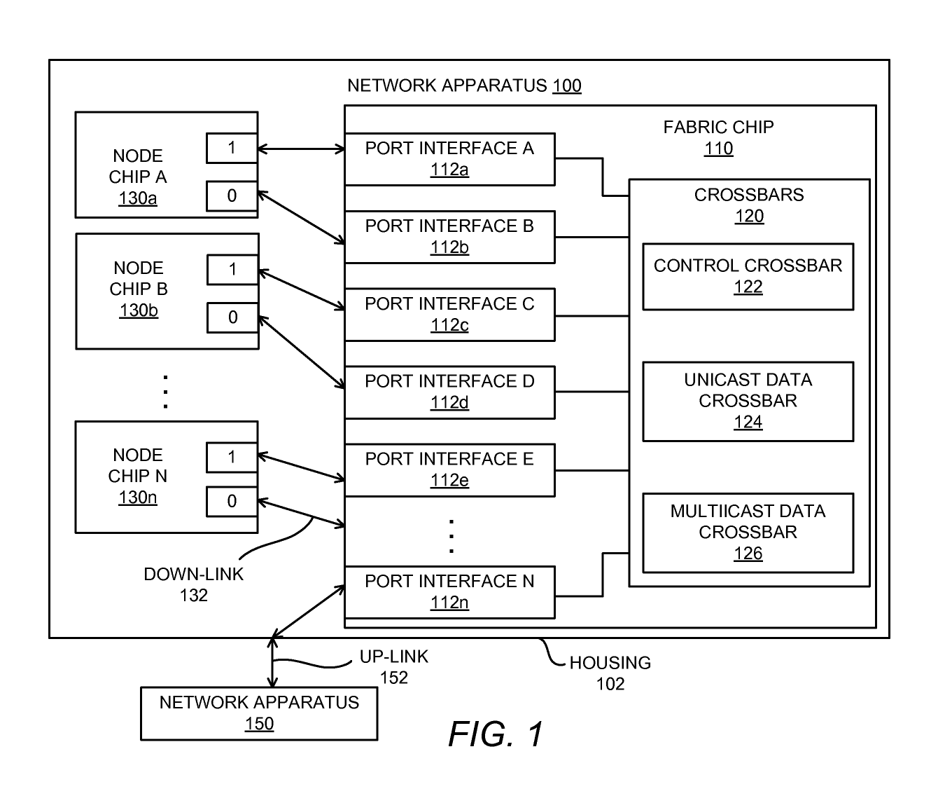

With reference first to FIG. 1, there is shown a simplified diagram of a network apparatus 100, according to an example. It should be readily apparent that the diagram depicted in FIG. 1 represents a generalized illustration and that other components may be added or existing components may be removed, modified or rearranged without departing from a scope of the network apparatus 100.

The network apparatus 100 generally comprises an apparatus for performing networking functions, such as, a network switch, or equivalent apparatus. In this regard, the network apparatus 100 may comprise a housing or enclosure 102 and may be used as a networking component. In other words, for instance, the housing 102 may be for placement in an electronics rack or other networking environment, such as in a stacked configuration with other network apparatuses. In other examples, the network apparatus 100 may be inside of a larger ASIC or group of ASICs within a housing. In addition, or alternatively, the network apparatus 100 may provide a part of a fabric network inside of a single housing.

The network apparatus 100 is depicted as including a fabric chip 110 and a plurality of node chips 130a-130n having ports labeled “0” and “1”. The fabric chip 110 is also depicted as including a plurality of port interfaces 112a-112n, which are communicatively coupled to respective ones of the ports “0” and “1” of the node chips 130a-130n. The port interfaces 112a-112n are also communicatively connected to a crossbar array 120, which is depicted as including a control crossbar 122, a unicast data crossbar 124, and a multicast data crossbar 126. The port interface 112n is also depicted as being connected to another network apparatus 150, which may include the same or similar configuration as the network apparatus 100. Thus, for instance, the another network apparatus 150 may include a plurality of node chips 130a-130n communicatively coupled to a fabric chip 110. As shown, the port interface 112n is connected to the another network apparatus 150 through an up-link 152. Alternatively, however, and as discussed in greater detail herein below, the network apparatus 100 and the another network apparatus 150 may communicate to each other through trunked links of a common trunk.

According to an example, the node chips 130a-130n comprise application specific integrated circuits (ASICs) that enable user-ports and the fabric chip 110 to interface each other. Although not shown, each of the node chips 130a-130n may also include a user-port through which data, such as, packets, may be inputted to and/or outputted from the node chips 130a-130n. In addition, each of the port interfaces 112a-112n may include a port through which a connection between a port in the node chip 130a and the port interface 112a may be established. The connections between the ports of the node chip 130a and the ports of the port interfaces 112a-112n may comprise any suitable connection to enable relatively high speed communication of data, such as, optical fibers or equivalents thereof.

The fabric chip 110 may comprise an ASIC that communicatively connects the node chips 130a-130n to each other. The fabric chip 110 may also comprise an ASIC that communicatively connects the fabric chip 110 to the fabric chip 110 of another network apparatus 150, in which, such connected fabric chips 110 may be construed as back-plane stackable fabric chips. The ports of the port interfaces 112a-112n that are communicatively coupled to the ports of the node chips 130a-130n through down-links 132 are described herein as “down-link ports”. In addition, the ports of the port interfaces 112a-112n that are communicatively coupled to the port interfaces 112a-112n of the fabric chip 110 in another network apparatus 150 through up-links 152 are described herein as “up-link ports”.

According to an example, packets enter the fabric chip 110 through a down-link port of a source node chip, which may comprise the same node chip as the destination node chip. The destination node chip may be any fabric chip port in the switch fabric, including the one to which the source node chip is attached. In addition, the packets include an identification of which node chip(s), such as a data-list, a destination node mask, etc., to which the packets are to be delivered by the fabric chip 110. In addition, each of the port interfaces 112a-112n may be assigned a bit and each of the port interfaces 112a-112n may perform a port resolution operation to determine which of the port interfaces 112a-112n is to receive the packets. More particularly, for instance, the port interfaces 112a through which the packet was received may apply a bit-mask to the identification of node chip(s) contained in the packet to determine the bit(s) identified in the data and to determine which of the port interface(s) 112b-112n correspond to the determined bit(s). In instances where the packet comprises a uni-cast packet, the port interface 112a may transfer the data over the appropriate crossbar 122-126 to the determined port interface(s) 112b-112n. However, when the packet comprises a multi-cast packet, the port interface 112a may perform additional operations during the port resolution operation to determine which of the port interfaces 112b-112n is/are to receive the multi-cast packet as discussed in greater detail herein below.

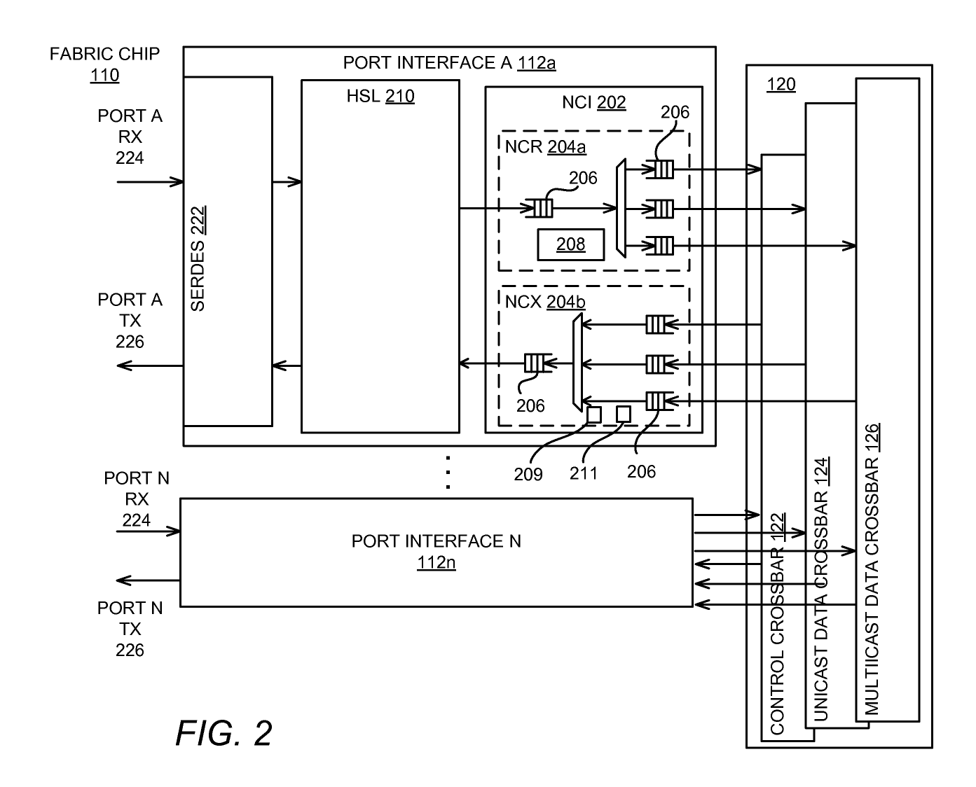

With particular reference now to FIG. 2, there is shown a simplified block diagram of the fabric chip 110 depicted in FIG. 1, according to an example. It should be apparent that the fabric chip 110 depicted in FIG. 2 represents a generalized illustration and that other components may be added or existing components may be removed, modified or rearranged without departing from a scope of the fabric chip 110.

The fabric chip 110 is depicted as including the plurality of port interfaces 112a-112n and the crossbar array 120. The components of a particular port interface 112a are depicted in detail herein, but it should be understood that the remaining port interfaces 112b-112n may include similar components and configurations.

As shown in FIG. 2, the fabric chip 110 includes a network chip interface (NCI) block 202, a high-speed link (HSL) (interface) block 210, and a set of serializers/deserializers (serdes) 222. By way of particular example, the set of serdes 222 includes a set of serdes modules. In addition, the serdes 222 is depicted as interfacing a receive port 224 and a transmit port 226. Alternatively, however, components other than the HSL block 210 and the serdes 222 may be employed in the fabric chip 110 without departing from a scope of the fabric chip 110 disclosed herein.

The NCI block 202 is depicted as including a network chip receiver (NCR) block 204a and a network chip transmitter (NCX) block 204b. The NCR block 204a feeds data received from the HSL block 210 to the crossbar array 120 and the NCX block 204b transfers data received from the crossbar array 120 to the HSL block 210. The NCR block 204a and the NCX block 204b are further depicted as comprising registers 206, in which some of the registers are communicatively coupled to one of the crossbars 122-126 and others of the registers 206 are communicatively coupled to the HSL block 210.

The NCI block 202 generally transfers data and control mini-packets (MPackets) in full duplex fashion between the corresponding HSL block 210 and the crossbar array 120. In addition, the NCI 202 provides buffering in both directions. The NCI block 202 also includes a port resolution module 208 that interprets destination and path information contained in each received MPacket. By way of example, each received MPacket may include a destination-node-chip-mask that the port resolution module 208 may use in performing a port resolution operation to determine the correct destination NCI block 202 in a different port interface 112b-112n of the fabric chip 110, to make the next hop to the correct destination node chip 130a-130n, which may be attached to a down-link port or an up-link port of the fabric chip 110. In this regard, the port resolution module 208 may be programmed with a resource, such as a bit-mask in which each bit corresponds to one of the port interfaces 112a-112n of the fabric chip 110. In addition, during the port resolution operation, the port resolution module 208 may use the bit-mask on the fabric-port-mask to determine which bits, and thus, which port interfaces 112b-112n, are to receive the packet. In addition, the port resolution module 208 interprets the destination and path information, determines the correct NCI block 202, and determines the ports to which the packet is to be outputted independently of external software. In other words, the port resolution module 208 need not be controlled by external software to perform these functions.

The port resolution module 208 may be programmed with machine-readable instructions that, when executed, cause the port resolution module 208 to determine that a first path in the switch fabric along which the packet is to be communicated toward the destination node is unavailable, to determine whether another path in the switch fabric along which the packet is to be communicated toward the destination node chip that does not include the source fabric chip is available, in response to a determination that the another path is available, to communicate the packet along the another path, and in response to a determination that the another path is unavailable, to communicate the packet back to the source fabric chip. In this regard the port resolution module 208 is only to communicate the packet back to the source fabric chip if there are no other available paths for the packet to take to reach the destination node chip.

The port resolution module 208 may also be programmed with machine-readable instructions that, when executed, cause the port resolution module 208 to determine whether a counter in the packet is to be modified (that is, incremented or decremented). The machine-readable instructions may also cause the port resolution module 208 to terminate the packet if the counter has rolled-over, that is, when the counter has reached a predetermined value (or zero). As discussed in greater detail herein below, the port resolution module 208 is to increment the counter in response to a determination that the packet has been detoured around an unavailable fabric link and that the packet is not making forward progress in the switch fabric.

The port resolution module 208 may also be programmed with information that identifies which of the port interfaces 112a-112n comprise up-links that are trunked links. As discussed in greater detail herein below, the port resolution module 208 may treat all of the trunked links as a common link for purposes of avoiding return of the packet back to the source fabric chip unless there are no further paths available over which the packet is able to reach the destination node chip.

The NCX block 204b also includes a node pruning module 209 and a unicast conversion module 2011 that operates on packets received from the multicast data crossbar 126. More particularly, the unicast conversion module 211 is to process the packets to identify a data word in the data that the node-chip on the down-link will need for that packet. In addition, the node pruning module 209 is to prune a destination node chip mask to a subset of the bits that represent which node chips are to receive a packet such that only destination node chips 130a-130n that were supposed to traverse the port are still included in the chip mask. Thus, for instance, if the NCX block 204b receives a multi-cast packet listing a chip node 130a of the fabric chip 110 and a chip node 130 attached to another network apparatus 150, the NCX block 204b may prune the data-list of the multi-cast packet to remove the chip node 130a of the fabric chip 110 prior to the multi-cast packet being sent out to the another apparatus 150.

The HSL block 210 generally operates to initialize and detect errors on the hi-speed links, and, if necessary, to re-transmit data. According to an example, the data path between the NCI block 202 and the HSL block 210 is 64 bits wide in each direction.

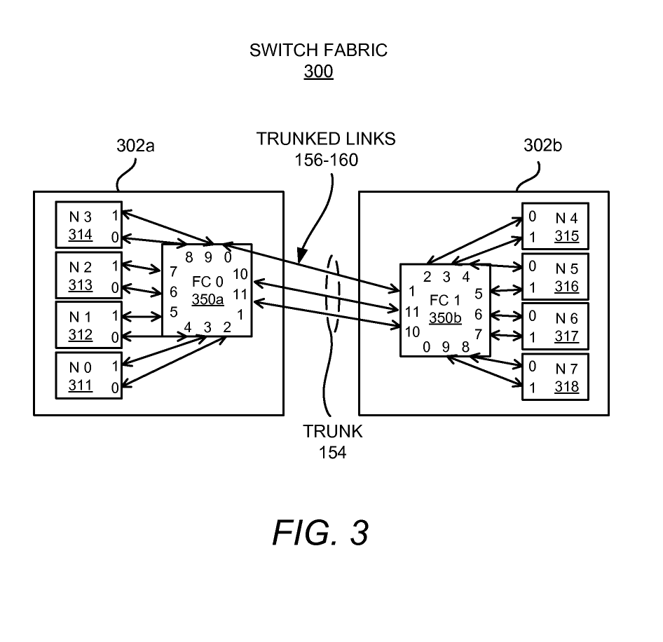

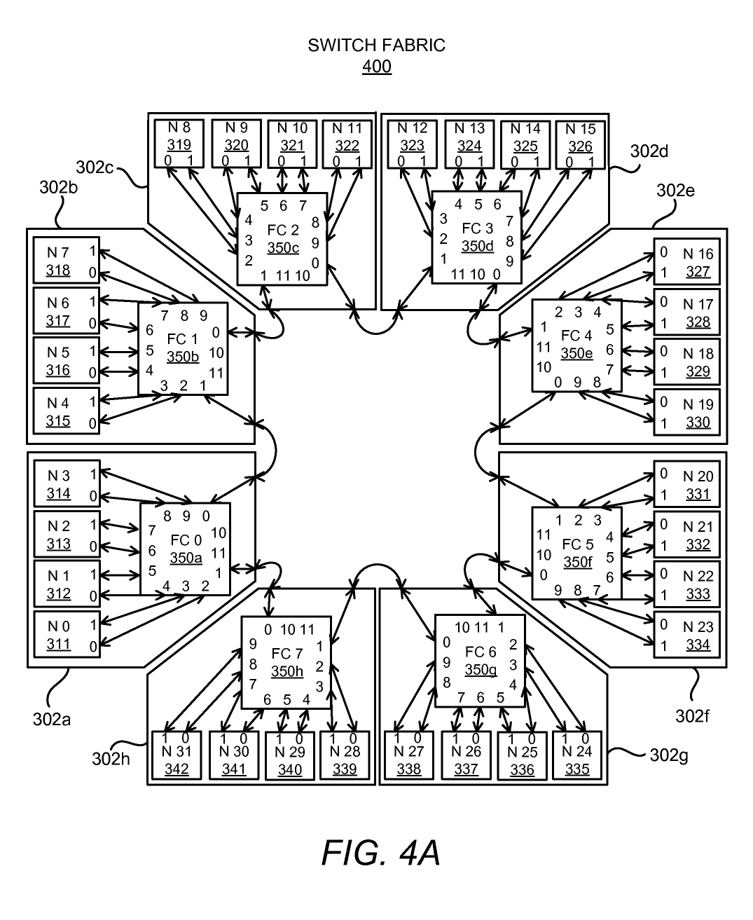

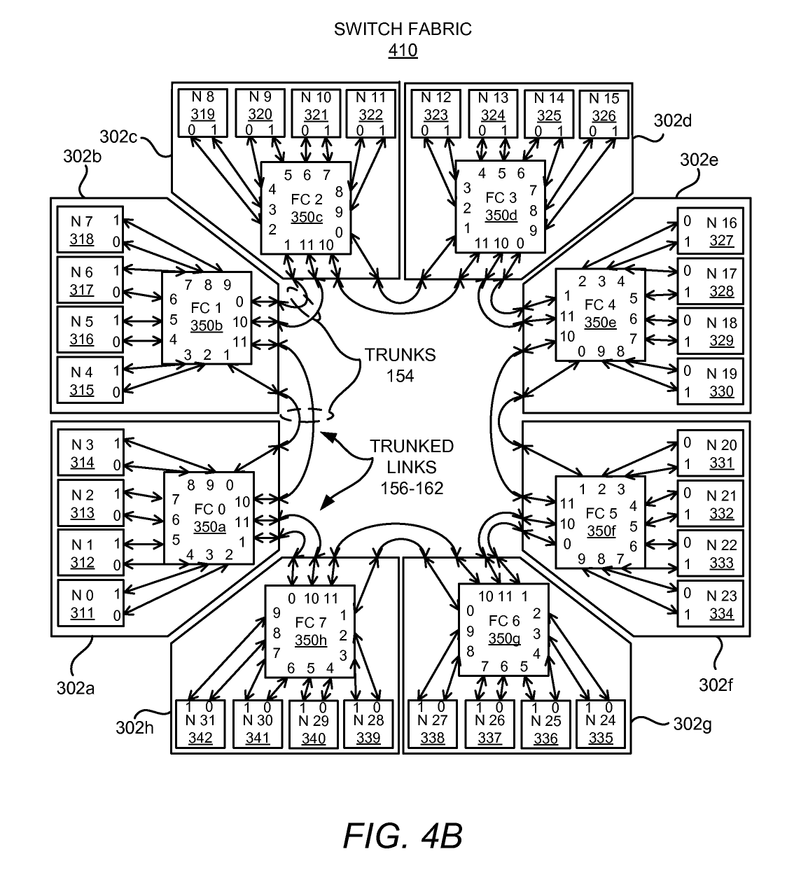

Turning now to FIGS. 3, 4A, and 4B, there are respectively shown simplified block diagrams of switch fabrics 300, 400, and 410, according to various examples. It should be apparent that the switch fabrics 300, 400, and 410 depicted in FIGS. 3, 4A, and 4B represent generalized illustrations and that other components may be added or existing components may be removed, modified or rearranged without departing from the scopes of the switch fabrics 300, 400, and 410.

The switch fabric 300 is depicted as including two network apparatuses 302a and 302b and the switch fabrics 400 and 410 are depicted as including eight network apparatuses 302a-302h. Each of the network apparatuses 302a-302h is also depicted as including a respective fabric chip (FC0-FC7) 350a-350h. Each of the network apparatuses 302a-302h may comprise the same or similar configuration as the network apparatus 100 depicted in FIG. 1. In addition, each of the fabric chips 350a-350h may comprise the same or similar configuration as the fabric chip 110 depicted in FIG. 2. Moreover, although particular numbers of network apparatuses 302a-302h have been depicted in FIGS. 3, 4A, and 4B, it should be understood that the switch fabrics 300, 400, and 410 may include any number of network apparatuses 302a-302h arranged in any number of different configurations with respect to each other without departing from scopes of the switch fabrics 300, 400, and 410.

In any regard, as shown in the switch fabrics 300, 400, and 410, the network apparatuses 302a-302h are each depicted as including four node chips (N0-N31) 311-342. Each of the node chips (N0-N31) 311-342 is depicted as including two ports (0, 1), which are communicatively coupled to a port (0-11) of at least one respective fabric chip 350a-350h. More particularly, each of the ports of the node chips 311-342 is depicted as being connected to one of twelve ports 0-11, in which each of the ports 0-11 is communicatively coupled to a port interface 112a-112n. In addition, the node chips 311-342 are depicted as being connected to respective fabric chips 350a-350h through bi-directional links. In this regard, data may flow in either direction between the node chips 311-342 and their respective fabric chips 350a-350h.

As discussed above with respect to FIG. 1, the ports of the fabric chips 350a-350h that are connected to the node chips 311-342 are termed “down-link ports” and the ports of the fabric chips 350a-350h that are connected to other fabric chips 350a-350h are termed “up-link ports”. Each of the up-link ports and the down-link ports of the fabric chips 350a-350h includes an identification of the destination node chips 311-342 that are intended to be reached through that link. In addition, the packets supplied into the switch fabrics 300, 400, and 410 include with them an identification of the node chip(s) 311-342 to which the packets are to be delivered. The up-link ports whose identification of node chips 311-342 matches one or more node chips in the identification of the node chip(s), or chip mask, is considered to be a “preferred up-link port” or “preferred up-link interface port”, which will receive the data to be transmitted, unless the “preferred up-link port” is dead or is otherwise unavailable. If a preferred up-link is dead or otherwise unavailable, the port resolution module 208 may use a programmable, prioritized list of port interfaces to select an alternate up-link port interface to receive the packet instead of the preferred up-link port.

The down-link ports whose list of a single node chip 311-342 matches one of the node chips in the identification of the node chip(s) are considered to be the “active down-link ports”. A “path index” is embedded in the packet, which selects which of the “active down-link ports” will be used for the packet. This path-based filtering enables a fabric chip 350a-350h to have multiple connections to a node chip 311-342.

In any regard, the fabric chips 350a-350h are to deliver the packet to the node chip(s) 311-342 that are in the identification of the node chip(s). For those node chips 311-342 contained in the identification of the node chip(s) that are connected to down-link ports of a fabric chip 350a, the fabric chip 350a may deliver the packet directly to that node chip(s) 311-314. However, for the node chips 315-342 in the identification of the node chip(s) that are not connected to down-link ports of the fabric chip 350a, the fabric chip 350a performs hardware calculations to determine which up-link port(s) the packet will traverse in order to reach those node chips 315-342. These hardware calculations are defined as “port resolution operations”.

As shown in FIG. 3, the fabric chip 350a of the network apparatus 302a is depicted as being communicatively connected to the fabric chip 350b of the network apparatus 302b through three trunked links 156-160, which are part of the same trunk 154. In FIG. 4A, each of the fabric chips 350a-350h is connected to exactly two other fabric chips 350a-350h. In FIG. 4B, each of the fabric chips 350a-350h is depicted as being connected to two neighboring fabric chips 350a-350h through two respective trunked links 156-158 and 160-162, which are part of two separate trunks 154.

The switch fabrics 400 and 410 depicted in FIGS. 4A and 4B comprise ring network configurations, in which each of the fabric chips 350a-350h is connected to exactly two other fabric chips 350a-350h. More particularly, ports (0) and (1) of adjacent fabric chips 350a-350h are depicted in FIG. 4A as being communicatively coupled to each other. In addition, ports (0) and (1) and (10) and (11) of adjacent fabric chips 350a-350h are depicted in FIG. 4B as being communicatively connected to each other. As such, a single continuous pathway for data signals to flow through each node is provided between the network apparatuses 302a-302h.

Although the switch fabric 300 has been depicted as including two network apparatuses 302a, 302b and the switch fabrics 400, 410 have been depicted as including eight network apparatuses 302a-302h, with each of the network apparatuses 302a-302h including four node chips 311-342, it should be clearly understood that the switch fabrics 300, 400, and 410 may include any reasonable number of network apparatuses 302a-302h with any reasonable number of links 152 and/or trunked links 156-162 between them without departing from the scopes of the switch fabrics 300, 400, and 410. In addition, the network apparatuses 302a-302h may each include any reasonably suitable number of node chips 311-342 without departing from the scopes of the switch fabrics 300, 400, and 410. Furthermore, each of the fabric chips 350a-350h may include any reasonably suitable number of port interfaces 112a-112n and ports. Still further, the network apparatuses 302a-302h may be arranged in other network configurations, such as, a mesh arrangement or other configuration.

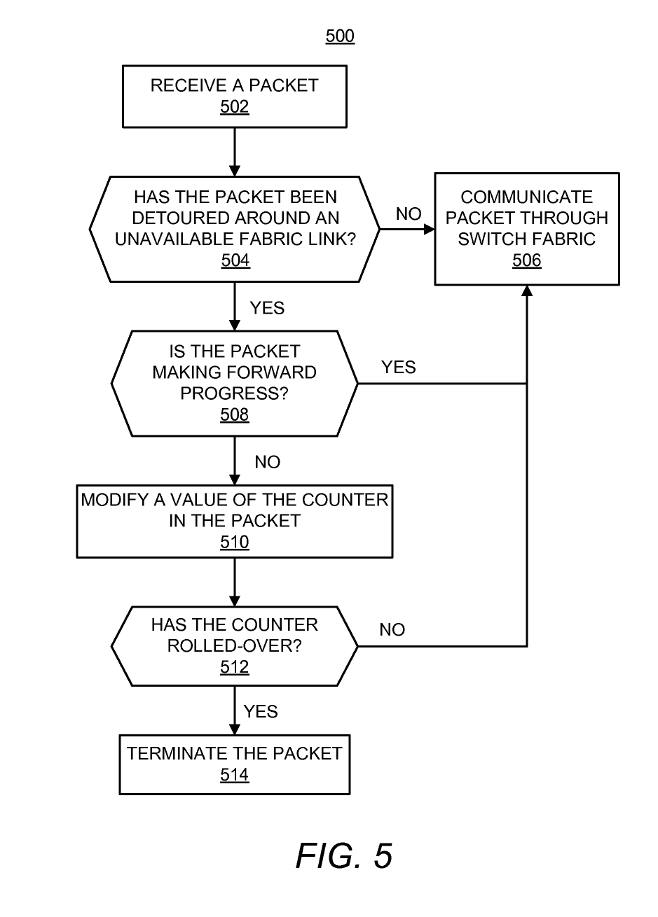

Various manners in which the switch fabrics 300, 400, and 410 may be implemented are described in greater detail with respect to FIG. 5, which depicts a flow diagram of a method 500 for managing packet flow in a switch fabric comprising fabric chips 110, 350a-350h, such as those depicted in FIGS. 1-4B, according to an example. It should be apparent that the method 500 represents a generalized illustration and that other operations may be added or existing operations may be removed, modified or rearranged without departing from the scope of the method 500.

The description of the method 500 is made with particular reference to the fabric chips 110 and 350a-350h depicted in FIGS. 1-4B. It should, however, be understood that the method 500 may be performed in fabric chip(s) that differ from the fabric chips 110 and 350a-350h without departing from the scope of the method 500. In addition, although reference is made to particular ones of the network apparatuses 302a-302h, and therefore particular ones of the fabric chips 350a-350h and the node chips 311-342, it should be understood that the operations described herein may be performed by and/or in any of the network apparatuses 302a-302h.

Each of the port interfaces 112a-112n of the fabric chips 110, 350a-350h may be programmed with the destination node chips 130a-130n, 311-342 that are to be reached through the respective port interfaces 112a-112n. Thus, for instance, the port interface 112a containing the port (2) of the fabric chip (FC0) 350a may be programmed with the node chip (N0) 311 as a reachable destination node chip for that port interface 112a. As another example, the port interface 112n containing the port (0) of the fabric chip (FC0) 350a may be programmed with the node chips (N4-N31) 315-342 or a subset of these node chips as the reachable destination node chips for that port interface 112n.

Each of the port interfaces 112a-112n of the fabric chips 110, 350a-350h may be programmed with identifications of which fabric links comprise trunked links. In addition, each of the port interfaces 112a-112n of the fabric chips 110, 350a-350h may be programmed with identifications of which trunked links are grouped together. Thus, for instance, the port interfaces 112a-112n of the fabric chip 350a may be programmed with information that the trunked links 156 and 158 are in a first trunk and that the trunked links 158 and 160 are in a second trunk.

Generally speaking, the method 500 depicted in FIG. 5 pertains to various operations performed by the fabric chips 350a-350h in response to receipt of a uni-cast or a multi-cast packet. The uni-cast or multi-cast packet may include various information, such as, an identification of the node chip(s) to which the packet is to be delivered, which is referred to herein as the “data-list”, a fabric-port-mask, a destination-chip-node-mask, a bit mask, a chip mask, a counter, etc. A “path index” may also be embedded in the packet, which selects which of a plurality of active down-link ports are to be used to deliver the packet to the destination node chip(s) contained in the identification. According to an example, the various information may be contained in a header of the packet. In addition, the various information may be contained in manners that substantially minimizes the amount of space occupied by the various information.

According to an example, the counter in the packet is sized to accommodate the maximum quantity of unrelated, failed fabric links (or fabric chips) in a switch fabric 300, 400, 410. In other words the size of the counter is related to a predetermined number of unavailable links that are expected to be tolerated in the switch fabric 300, 400, 410 at one time. Thus, the counter is not sized based upon the size of the switch fabric 300, 400, 410. In this regard, for instance, the counter may be sized to comprise two bits of state information. As discussed in greater detail below, the counter is to be incremented when the packet is determined to have been detoured around an unavailable fabric link and the packet is not making forward progress.

With reference to FIG. 5, at block 502, a fabric chip 350a receives a packet from a source fabric chip 350b, for instance, through a first port interface 112a in the first fabric chip 350a. The fabric chip 350a may receive the packet through an up-link port of the source fabric chip 350b. In any event, and as depicted in FIG. 2, the packet may be received into the first port interface 112a through the receipt port 224, into the serdes 222, the DIB 220, the HSL 210, and into a register 206 of the NCR 204a.

At block 504, a determination, in the fabric chip 350a, as to whether the packet has been detoured around an unavailable fabric link is made. More particularly, for instance, a port resolution module 208 of a port interface that has unsuccessfully attempted to communicate the packet to another port interface may determine that the path to the another port interface is unavailable. The port resolution module 208 may determine that a path is unavailable, for instance, if a path associated with a selected port interface through which the packet is to be communicated is dead or is otherwise unavailable. The port resolution module 208 may make this determination based upon a prior identification that communication of a packet was not delivered through that port interface 112b-112n. The port resolution module 208 may also make this determination by determining that an attempt to communicate the packet to that port interface 112b-112n has failed. In addition, or alternatively, the port resolution module 208 may determine that a path is unavailable if an acknowledgement message is not received from a destination fabric chip to which an attempt has been made to communicate the packet. In this example, the port interface on the destination fabric chip may be dead or otherwise unavailable or a connection between the port interfaces in the fabric chip 350a and the destination fabric chip 350h may have been severed or is otherwise inactive.

The packet may therefore be identified as having been detoured around an unavailable fabric link if an attempt to communicate the packet to another fabric chip or node chip is unsuccessful. According to a particular example, the counter in the packet may be modified, indicating that such an unsuccessful communication attempt has been made. In this example, any of the port interfaces 112a-112n in any of the fabric chips 350a-350c may determine whether the packet has been detoured around an unavailable fabric link through a determination as to whether that bit has been set.

If the port interface 112a determines that the packet has not been detoured around an unavailable fabric link at block 504, the port interface 112a communicates the packet through the switch fabric 300, 400, 410 as indicated at block 506. In other words, the port resolution module 208 of the port interface 112a determines the next down-link and/or up-link for the packet to traverse to reach its intended destination(s) node chip(s) 311-342 through performance of any of the operations discussed above. Moreover, the packet is communicated to the determined down-link and/or up-link. In the event that the packet is received into a port interface of another fabric chip 350c, that port interface may also perform the method 500 beginning at block 502. As such, each of the remaining port interfaces of the fabric chips 350a-350h that receive the packet as part of the packet flow may perform the method 500 beginning at block 502.

However, if the port interface 112a determines that the packet has been detoured around an unavailable fabric link at block 504, the port interface 112a determines whether the packet is making forward progress through the switch fabric 300, 400, 410. More particularly, for instance, the port interface 112a determines that the packet is making forward progress if at least one of the following two conditions is met: i) the packet is to be sent to or from to a down-link port interface of the fabric chip 350a; and ii) the packet is to be sent to a preferred up-link port interface of the fabric chip 350a. As discussed above, a “preferred up-link port interface comprises an up-link port whose identification of node chips 311-342 matches one or more node chips in the identification of node chip(s) or chip mask contained in the packet.

If the port interface 112a determines that the packet is making forward progress, the port interface 112a communicates the packet through the switch fabric 300, 400, 410 as indicated at block 506. However, if the port interface 112a determines that the packet is not making forward progress, that is, neither of the conditions above is being met, the port interface 112a modifies a value of the counter in the packet, as indicated at block 510. More particularly, the port interface 112a modifies the counter in the packet in response to both the packet having been detoured around an unavailable fabric link at block 504 and the packet failing to make forward progress at block 508. The counter may be incremented or decremented depending upon the manner in which the counter is to be used. For instance, if the counter is to be reset when the counter reaches a predetermined value, the counter may initially be set to zero “0” and incremented. In contrast, if the counter is to be reset when the counter reaches a zero value, the counter may initially be set to a predetermined value as discussed above, and may be decremented from that predetermined value.

At block 512, the port interface 112a determines if the counter has rolled-over. In other words, the port interface 112a determines if the counter of the packet has reset to either zero or to the predetermined value. The number of times that the counter may be incremented (or decremented) prior to being rolled-over or resetting, may be based upon a predetermined number of unavailable fabric links that are expected to be tolerated in the switch fabric 300, 400, 410 at one time.

If the port interface 112a determines that the counter has not rolled-over at block 512, the port interface 112a communicates the packet through the switch fabric 300, 400, 410 as indicated at block 506. However, if the port interface 112a determines that the counter has rolled-over at block 512, the port interface 112a terminates the packet, as indicated at block 514. According to an example, the port interface 112a terminates the packet by sending the packet to zero destinations.

Accordingly, the packet may be removed from the switch fabric 300, 400, 410 once a fabric chip 350a-350n determines that the conditions described in the method 500 have been met.

What has been described and illustrated herein are various examples of the present disclosure along with some of their variations. The terms, descriptions and figures used herein are set forth by way of illustration only and are not meant as limitations. Many variations are possible within the spirit and scope of the present disclosure, in which the present disclosure is intended to be defined by the following claims—and their equivalents—in which all terms are mean in their broadest reasonable sense unless otherwise indicated.

What is claimed is:

1. A method for managing packet flow in a switch fabric comprising a plurality of fabric chips, wherein a packet comprises a counter, said method comprising:
determining whether the packet has been detoured around an unavailable fabric link;
determining whether the packet is making forward progress; and
modifying a value of the counter in the packet in response to a determination that the packet has been detoured around an unavailable fabric link and a determination that forward progress is not being made.

2. The method according to claim 1, further comprising:
continuing to communicate the packet through the switch fabric in response to at least one of a determination that the packet has not been detoured around an unavailable fabric link and a determination that the packet is making forward progress.

3. The method according to claim 1, further comprising:
determining whether the counter has rolled-over; and
in response to the counter having rolled-over, terminating the packet from the packet flow.

4. The method according to claim 3, wherein terminating the packet further comprises terminating the packet by sending the packet to zero destinations.

5. The method according to claim 3, further comprising:
in response to the counter not having rolled-over, continuing to communicate the packet to flow through the switch fabric.

6. The method according to claim 1, wherein each of the plurality of fabric chips comprises a plurality of port interfaces, and wherein determining whether the packet has been detoured around an unavailable fabric link, determining whether the packet is making forward progress, and modifying the value of the counter are performed in at least one of the plurality of port interfaces.

7. The method according to claim 6, wherein determining whether the packet is making forward progress further comprises:
in a fabric chip of the plurality of fabric chips, determining that the packet is making forward progress if at least one of the following conditions is met:
the packet is to be sent to or from a down-link port interface of the fabric chip; and
the packet is to be sent to a preferred up-link port interface of the fabric chip.

8. A switch fabric comprising:
a plurality of fabric chips, each of said plurality of fabric chips comprising a plurality of port interfaces to communicate a packet among each other and to destination node chips, wherein the packet comprises a counter, and wherein the plurality of port interfaces are to,
determine whether the packet has been detoured around an unavailable fabric link;
determine whether the packet is making forward progress; and
modify a value of the counter in the packet in response to a determination that the packet has been detoured around an unavailable fabric link and a determination that forward progress is not being made;
determining whether the counter has rolled-over; and
in response to the counter having rolled-over, terminate the packet from the packet flow.

9. The switch fabric according to claim 8, wherein the plurality of port interfaces are further to continue to communicate the packet through the switch fabric in response to at least one of a determination that the packet has not been detoured around an unavailable fabric link and a determination that the packet is making forward progress.

10. The switch fabric according to claim 8, wherein the plurality of port interfaces are to determine that the packet is making forward progress if at least one of the following conditions is met:
the packet is to be sent to or from a down-link port interface of the fabric chip; and
the packet is to be sent to a preferred up-link port interface of the fabric chip.

11. The switch fabric according to claim 8, wherein the counter of the packet is sized to accommodate a predetermined number of unavailable links that are expected to be tolerated in the switch fabric at one time.

12. A fabric chip comprising:
a plurality of interface ports to communicate a packet among each other and to destination node chips, wherein the packet comprises a counter, and wherein the plurality of interface ports are to,
determine whether the packet has been detoured around an unavailable fabric link;
determine whether the packet is making forward progress; and
modify a value of the counter in the packet in response to a determination that the packet has been detoured around an unavailable fabric link and a determination that forward progress is not being made;
determining whether the counter has rolled-over; and
in response to the counter having rolled-over, terminate the packet from the packet flow.

13. The fabric chip according to claim 12, wherein the plurality of port interfaces are further to continue to communicate the packet through a switch fabric in which the fabric chip is used in response to at least one of a determination that the packet has not been detoured around an unavailable fabric link and a determination that the packet is making forward progress.

14. The fabric chip according to claim 12, wherein the plurality of port interfaces are to determine that the packet is making forward progress if at least one of the following conditions is met:
the packet is to be sent to or from a down-link port interface of the fabric chip; and
the packet is to be sent to a preferred up-link port interface of the fabric chip.

15. The fabric chip according to claim 12, wherein the counter of the packet is sized to accommodate a predetermined number of unavailable links or of unavailable fabric chips that are expected to be tolerated in the switch fabric at one time.
